(19) United States
(12) Patent Application Publication
(10) Pub. No.: US 2005/0216241 A1
(43) Pub. Date: Sep. 29, 2005

(54) Method and apparatus for gathering statistical measures

(76) Inventors: Gadi Entin, Hod Hasharon (IL); Smadar Nehab, Tel Aviv (IL)

Correspondence Address: GLENN PATENT GROUP, 3475 EDISON WAY, SUITE L, MENLO PARK, CA, 94025, US

(21) Appl. No.: 11/092,447

(22) Filed: Mar. 28, 2005

Related U.S. Application Data
(60) Provisional application No. 60/556,902, filed on Mar. 29, 2004.

(51) Int. Cl. G06F 17/10

(52) U.S. Cl. 703/2

(57) ABSTRACT

According to the invention, a data model and method and apparatus for performing content and context modeling are disclosed. The method dynamically classifies and gathers selective information on various monitored systems to detect content related problems and provide context for diagnosing the root cause of these problems. The selected, monitored information for classification is converted to a plurality of dimensions that may be preconfigured, added incrementally after the monitored system is in production, or when a need for more advanced analysis or for wider context arise.

### CROSS REFERENCE TO RELATED APPLICATIONS

This application claims priority from U.S. provisional patent application Ser. No. 60/556,902, filed on Mar. 29, 2004, the entire disclosure of which is incorporated herein by reference thereto.

### BACKGROUND OF THE INVENTION

1. Technical Field

The invention relates generally to automated systems for monitoring the performance of enterprise software applications. More particularly, the invention relates to automated systems for monitoring such applications by performing content and context modeling, as well as analysis.

2. Discussion of the Prior Art

Web services, or the use of service oriented architecture (SOA) to integrate applications, are being adopted by the information technology industry for many reasons. The integrated applications are referred to hereinafter as “enterprise software applications” (ESAs). Typically, an ESA includes multiple services connected through standard based interface. For example, FIG. 1 is a block schematic diagram of an ESA 100 designed as a car rental application. The ESA 100 comprises several independent services 110-1 through 111-4, each operating on a different platform. The services are all connected to an enterprise message bus 120, which enables each of the services to post a request to any other service or to serve a request submitted by any other service. In this example, the service 110-4 is a website that allows a customer to make vehicle reservations through the Internet, the service 110-1 is a partner system, such as an airline, hotel, and travel agent, the service 110-2 is a legacy accounting application, and service 110-3 is a pricing function. The services 111 communicate with each other using communication protocols including simple object access protocol (SOAP), hypertext transfer protocol (HTTP), extensible markup language (XML), Microsoft message queuing (MSMQ), Java message service (JMS), and the like.

The successful operation of an ESA depends on the ability to serve the customers requests properly and in a timely manner. Typically, an ESA often needs to run 24/7, i.e. twenty four hours a day and every day of the year. As a result, there is an on-going challenge to develop effective techniques for reliable detection of abnormal behavior and for providing alerts when irregular behavior is detected.

In the related art, a few monitoring systems capable of detecting abnormal behavior of monitored applications (or systems) are disclosed. Specifically, a typical monitoring system applies historical usage data to analyze and detect normal usage patterns of the monitored application. Based on these normal usage patterns, one or more predictive functions for the normal operation are generated. The monitoring system is then set according to the predictive function with alarm thresholds that track the expected normal operational pattern. The usage data are collected by capturing messages and transactions exchanged via the different services of an ESA.

The monitoring solutions disclosed in the related focus on individual silos of the ESA, such as a server, an application, and a user response-time. These solutions are further focused on one layer of the IT stack, and monitor and manage the stack rather than taking the point of view of the ESA deployment. Moreover, these systems monitor well defined and known resources, e.g. a server, a network, a CPU, a memory, a disk, and known performance metrics. Furthermore, the existing solutions do not analyze the content and context of service functions integrated in an ESA, and thus cannot examine the relationship between services and their underlying business functionality as well as application logic. For example, to track events sent from a partner airline, prior art systems monitor, events received from a physical connection (e.g., an IP address) determined at the deployment of the system 100. These parameters are not sufficient in generic ESA environments and require time consuming and error prone customization.

In the view of the shortcomings introduced in the related art, it would be, advantageous to provide a solution that monitors the content and context of services to determine a class of application problems that are not defined both as performance and availability problems.

### SUMMARY OF THE INVENTION

According to the invention a data model and method and apparatus for performing content and context modeling are disclosed. The method dynamically classifies and gathers selective information on various monitored systems to detect content related problems and provide context for diagnosing the root cause of these problems. The selected, monitored information for classification is converted to a plurality of dimensions that may be preconfigured, added incrementally after the monitored system is in production, or when a need for more advanced analysis or for wider context arise.

### BRIEF DESCRIPTION OF THE DRAWINGS

FIG. 1 is a block schematic diagram of an enterprise software application architecture of a car rental system;

FIG. 2 is a block schematic diagram of an automated monitoring system used for demonstrating the principles of the invention;

FIG. 3 is a diagram of a format that is used to hold content derived from incoming messages;

FIG. 4 is a block diagram of a data model provided by the invention; and

FIG. 5 is a flowchart describing a method for performing context modeling according to the invention

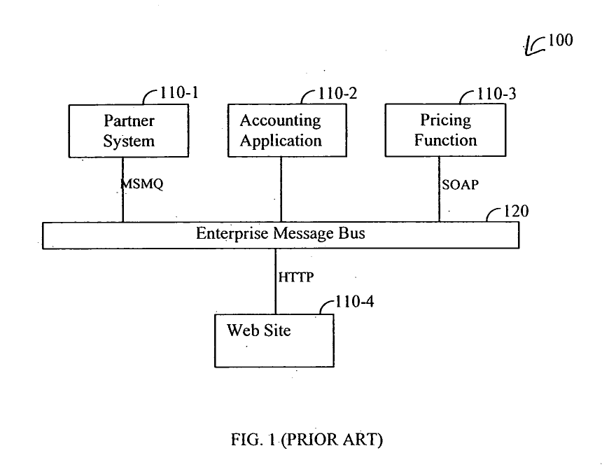

### DETAILED DESCRIPTION OF THE INVENTION

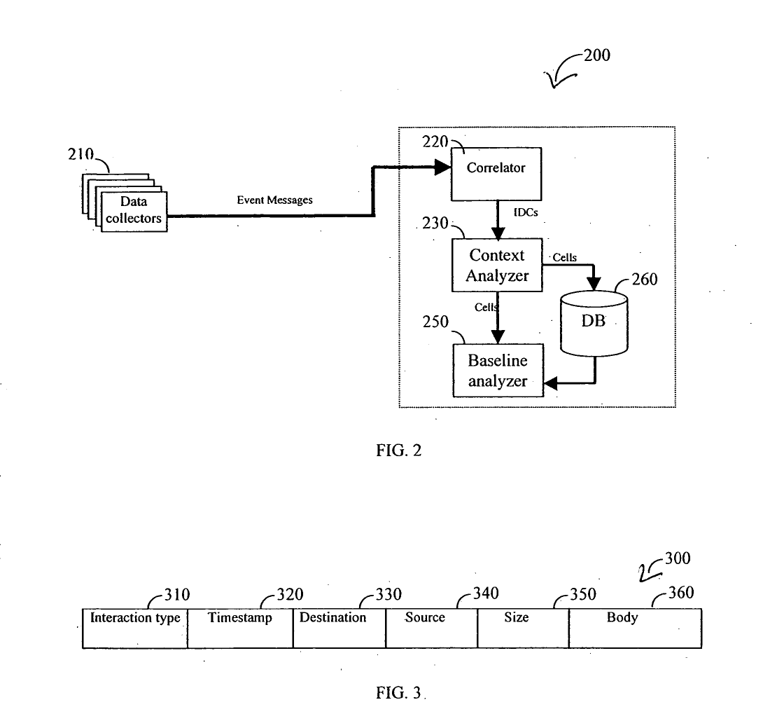

FIG. 2 a non-limiting and exemplary block diagram of an automated monitoring system 200 used for demonstrating the principles of the invention shown. The system 200 comprises a plurality of data collectors 210, a correlator 220, a context analyzer 230, a database 240, and baseline analyzer 250.

Data collectors 210 are deployed to the services, e.g. service 110, infrastructure that they monitor, and capture service call data that are passed between the various services. The data collectors 210 are non-intrusive, namely they do not impact the behavior of the monitored services in any way. The data collectors 210 capture service call data transmitted using communication protocols including, but not limited to, SOAP, XML, HTTP, JMS, MSMQ, and the like.

Each service call features at least one raw message, which includes at least a message name, as well as the content inherent to the message. The system 200 also collects metadata information which, together with the message data, the system 200 derives the sender, receiver, and the content thereof.

FIG. 3 shows a diagram of a format 300 that includes information derived from incoming messages. The format 300 is reported by the data collectors 210 after extracting relevant data from the original message based on required dimensions and tuple schemas of the model. The format 300 preferably includes the following fields: an interaction type 310, a timestamp 320, a destination 330, a source 340, a size 350, and a body 360.

The interaction type field 310 defines the message direction and may be one of: a client-outgoing, i.e. a request message recorded at a client, a client-incoming, i.e. a response message recorded at a client, a server-incoming, i.e. a request message recorded at a server, a server-outgoing, i.e. a response message logged at a server, and a one-way, i.e. a message to or from a proxy gateway, as recorded at the proxy. The first four interaction types may be observed at service functions that communicate using a synchronized communication protocol, e.g., SOAP over HTTP. The one-way interaction type is typically used by service functions that use an asynchronous communication medium. The timestamp field 320 includes the coordinated universal time (UTC) when the message is captured. This time may be expressed as the number of milliseconds since Jan. 1, 1970. The destination field 330 and source field 340, respectively include information on service, function, and server of the destination or source computer, i.e. a client or a server. The content of these fields is populated differently for different types of communication protocols, i.e. the synchronous or asynchronous protocols mentioned above. The size field 350 includes the total size of the original message, i.e., the message as captured by a data collector 210. The body field 360 contains the content of the message in a declarative language, e.g. XML. If the original message's content is not represented in a XML, then it is converted to XML. If such conversation is not possible, the body field 360 is left empty.

The data collectors 210 may also capture and collect other pieces of information that are for analyzing the monitored ESA. For example, the data collectors 210 collect raw messages, exchanged between the components of the monitored ESA, parameters related to the monitored ESA, and so on. All information collected by data collectors is referred hereinafter as a raw object.

The correlator 220 classifies raw objects received from the data collectors 210 into events. Each event represents a one-directional message as collected by a single collector 210. Each event includes one or more dimension values, as generated by the collectors 210, from the original message data. The dimension values are based on the dimensions, i.e. monitored entities, of interest as defined by the users. The conversion from message data to dimensions may be done using an XML X-path expression or may be determined by the user through an expressive and human readable language. This language may include a collection of Boolean logic expression using field names of the input data classes. For example, to extract an application error code it is necessary to analyze each response message generated by the application.

In one embodiment of the invention, the events are classified as input data classes (IDCs). Each IDC contains a series of messages satisfy the same logic rule. According to this embodiment, correlator 220 classifies input messages into three different types of IDCs: 1) one-way message; 2) request-to-response messages; and 3) a transaction branch. The context analyzer 230 is capable of analyzing streams of events regardless to their types. In an embodiment of the invention, the events processed by the context analyzer 230 can be represented in a canonical representation. This representation can be thought of as a set of pairs of name values. Each such pair represents dimension and dimension value, and thus defines the context to be derived for the event. A canonical message structure can be represented as follows:
{<DIM₁, DV₁>, <DIM₂, DV₂>, <DIM₃, DV₃>, . . . , <DIMₙ, DVₙ>} (1)

A stream of events, or events in a canonical representation, is sent to the context analyzer 230 which analyzes the events for the purpose of statistics gathering. The context analyzer 230 classifies each event into all the tuple schemas that their dimensions were defined as part of a data model for the event. The data model provided by the invention is described in greater detail below. Each combination of dimension values per such tuple schema defines the specific tuple to which the event belongs. If such tuple exists, the event is added to the statistics of that tuple. Otherwise, a new tuple is created and the event is added to the new tuple. In both cases the metrics measured on the event, e.g. a response time or a throughput, are added to the statistics of the tuple. The statistics are later used for determining a baseline for each of the tuples and therefore, they define the normal context of the event. Such statistics can contribute valuable information on service performance. As an example, monetary information, e.g. a price quote can be derived by looking at return results. Statistics are gathered on objects that allow generating reports meaningful for users. Particularly, statistics are aggregated and dimension defined in the data model. The extraction of dimension values and the creation of new tuples are performed on the fly.

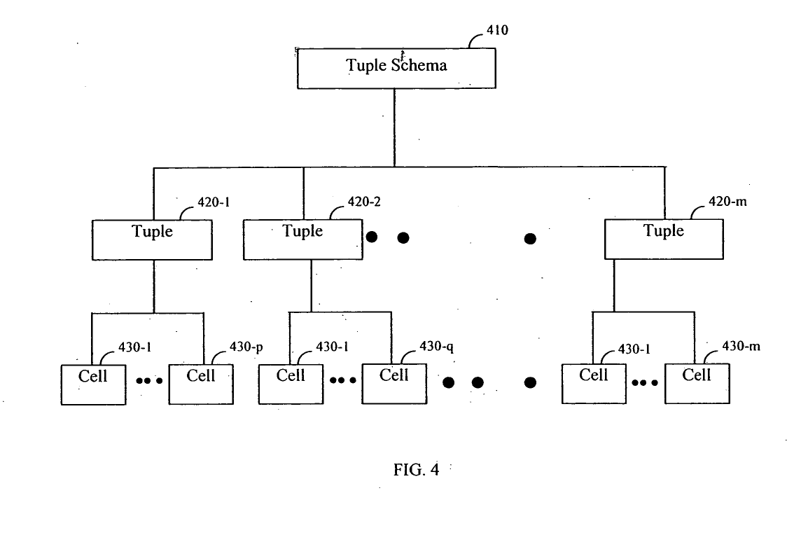

FIG. 4 shows the structure of a data model 400 constructed in accordance with an embodiment of the invention. The data model 400 is a hierarchal structure that is needed to define the context of the monitored entities and to aggregate statistics on these entities. The data model 400 comprises at least a tuple schema 410, a collection of tuples 420 of respective tuple schema, and a plurality of groups of cells 430, each related to a single tuple 420.

The automated monitoring system 200 collects information on many monitored entities of the monitored ESA. The monitored entities are either pre-defined or can optionally be defined dynamically by the user. Monitored entities are determined by dimensions, and the context in which these dimensions are analyzed is defined by the tuple schema 410. The tuple schema 410 is a combination of one or more dimensions and at least one measure value. A tuple schema defines the relationship between dimensions. A tuple schema 410 can be represented as:
TS=:<DIM₁, DIM₂, . . . , DIMₘ, MV₁, MV₂, . . . , MVₙ>. (2)

A dimension (DIM) is a function that operates on incoming events. Specifically, the dimension function determines if an event is relevant for a domain of values and further what values are relevant to this dimension. For example, a user may define an airline partner dimension, where the domain of values for this dimension is a list of all partner names. Applying this dimension on an event would result in accumulating statistics to a specific airline partner.

The context analyzer 230 is preconfigured with a list of dimensions including, but not limited to, a service, a function, i.e. a method call in a service, a service link, i.e. a combination of a service and a function, a transaction, i.e. a group of service transaction brunches, a partner system, and so on. In addition, the context analyzer 230 is preconfigured with a list of tuple schemas including, but not limited to, a service by function, transactions by service functions, all services, all functions, and so on. The dimensions and tuple schemas can be defined by a user and can be added incrementally after the system is in production and when a need for more advanced monitoring and analysis arises. For example, a user may add a dimension of an error code and thus monitor the application errors as returned by the service to its client.

A measured value (MV) is a function that operates on the events as they are classified into tuples to gather numeric values that can be statistically aggregated over time. Measured values, measured by the context analyzer 230 may be, but are not limited to, throughput, response time, monetary values, and many others.

Each of tuples 420 is derived from a respective tuple schema 410 and includes a collection of values from the dimensions designated in the tuple schema. A tuple 420 may be represented as:
T=:<DV₁, DV₂, . . . , DV_{M}> (3)
where DV₁, DV₂, . . . , DV_{M} are the values respectively collected for dimensions DIM₁, DIM₂, . . . , DIMₘ at a time interval. Examples of dimension values include a list of all partner names for a partner dimension, a list of transaction branches, and more. Each cell 430 comprises a collection of values for a respective tuple 420 received and aggregated over a configurable time period. A cell 430 may be represented as follows:
Cell=:<T₁, SM₁, SM₂, . . . , SMₙ, Start-Time> (4)
where, a tuple Tᵢ is associated with a tuple 420 and a statistical measure SMᵢ is related to a measured value MVᵢ. For example, if a value MVᵢ is a throughput, then SMᵢ is the number of counted occurrences of dimension values defined in Tᵢ. The Start-Time value is the time in which the first event was received. For the sake of simplicity, only a single tuple schema is depicted in FIG. 4. Typically, the number of tuple schemas, tuples, and cells is on the order of tens, hundreds, and thousands respectively.

Following is a non-limiting example of a data model. A tuple schema TS₁ includes the dimensions partner and version, as well as measured values throughput and response time. That is,
TS₁=<partner, version, throughput, response time> (5)

The partner dimension value is an airline partner of a car rental company, referring to the car rental system example mentioned above, while the version dimension is the version of the protocol through which the airline partner communicates with the car rental system. In other words, TS₁ allows the gathering of information of partners sending a message to a service employing a certain message protocol version. Dimension values are extracted from events, e.g. canonical messages or IDCs, and logged in tuples T₁ and T₂. The content of T₁ is, for example, <Continental, 1.001>, while the content of T₂ is, for example, <Delta, 1.002>. This means that the Continental's reservation system sends a message for a rental car system using a protocol version “1.001” and that the Delta's system sends a message using a protocol version “1.002”. Cells generated for T₁ and T₂ include the average response time for a request sent from a partner airline system and the number of calls. For instance, cell, includes the following values: <T₁, 4, 560 ms, 10:23> where T₁ is tuple T₁ defined above, 4 and 560 ms are the measured throughput and response time, and 10:23 is the time when a first raw object from which the information arrived.

The context analyzer 230 classifies events to the tuples to which they belong and calculates the statistics according to the measured values defined in the tuple schemas. For example, a ‘cancel’ message received from an airline partner ‘Delta’ can be classified to a two-dimensional tuple <cancel, Delta> as well as one-dimensional tuple including only the ‘cancel’ message <cancel>. Each of the statistical values is calculated for a specified and configurable time period. The results of the computed statistical variables are kept in the cells 430. The cells 430 are saved in a database 240 and further used by the baseline analyzer 250 to determine normal behavior of the monitored ESA. An example for the operation of baseline analyzer 250 may be found in the U.S. patent application entitled “Method for Detecting Abnormal Behavior of Enterprise Software Applications” assigned to the common assignee and which is hereby incorporated herein in the entirety by this reference thereto.

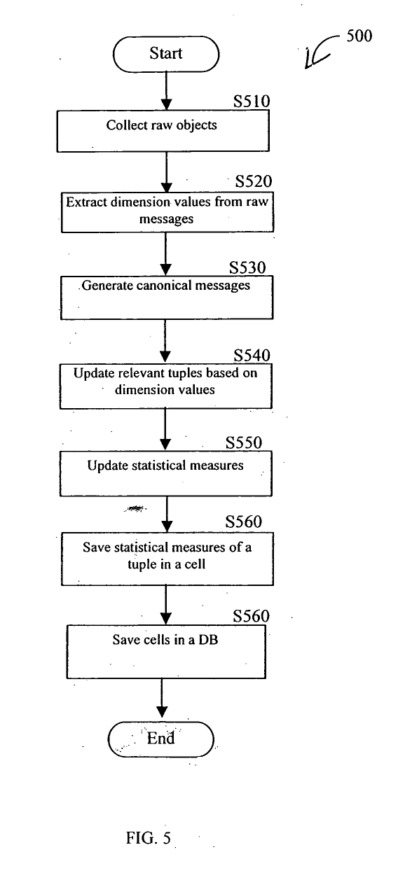

FIG. 5 is a flowchart 500 describing a method for performing content and context modeling in accordance with an embodiment of the invention. Prior to the execution of this method, a data model that includes the definitions of dimensions and tuple schemas is determined. At step S510, raw objects on the monitored ESA are collected. Raw objects may be, but are not limited to, raw messages, system parameters, service calls, or any other information that can be collected on the monitored entity. At step S520, dimension values for dimensions, defined in the data model are derived. The dimension values are derived using extraction expressions or functions applied on the raw objects. At step S530, a canonical message structure is generated based on the dimension values. The canonical message structure comprise pairs of dimensions and dimension values associated with these dimension, i.e., {<DIM₁, DV₁>, <DIM₂, DV₂>, . . . <DIMₙ, DVₙ>}. At step S540, relevant tuples are updated based on the dimension values in the canonical messages and according to the definition of the respective tuple schema. As a non-limiting example, a given data model includes the following tuple schemas:
TS₁=<DIM₁>; (6)
TS₂=<DIM₂>; (7)
TS₃=<DIM₁, DIM₂>; and (8)
TS₃=<DIM₁, DIM₂, DIM₃>. (9)

An input canonical message generated from a collected raw object is: {<DIM1, DV1>, <DIM2, DV2>, <DIM3, DV3>}. For the above tuple schemas and the canonical message four different tuples can be updated with the dimension values of the canonical message. These tuples are:
T₁=<DV₁>; T₂=<DV₂>; T₃=<DV₁, DV₂>; and T₄=<DV₁, DV₂, DV₃>. (10)

If a tuple does not exist then a new tuple is created and dimension values are added to this tuple. At step S550, statistical measures of dimension values of a respective tuple are updated based on the measured value (or values) defined for this tuple in the respective tuple schema. At step S560, the statistical measures, together with the respective tuple and a time indication, are saved in a cell. The time indication is the time when a first occurrence of a statistical value arrives. At step S570, each cell is saved in the database 240 and sent to the baseline analyzer 250.

It should be appreciated by a person skilled in the art that using the invention ESAs can be monitored without being coupled to the physical deployment of the ESAs. For example, to track events sent from the partner airline, the invention detects the partner by analyzing the content of all raw objects populated by the ESA. This is opposed to prior art systems that monitor and analyze only messages received from a physical connection through which the partner system is connected. This connection is determined at the deployment of monitored application.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. A method for context modeling to detect content related problems in a monitored system and diagnose a root cause of said problems, said method comprising the steps of:
defining a data model comprising at least a plurality of dimensions and a plurality of tuple schemas; wherein each of said plurality of dimensions defines content to be collected and each of said plurality of tuple schemas defines a context in which said content is analyzed;
collecting a plurality of raw objects on said monitored system;
dynamically deriving dimension values on said plurality of dimensions from said raw objects to generate events;
dynamically classifying each of said events to tuples based on the dimension values of each said events; and
for each of said tuples computing statistical measures based on at least one measure value defined in said tuple schema.

2. The method of claim 1, wherein said statistical measures of each of said tuples are aggregated over a specific interval.

3. The method of claim 2, wherein said step of computing statistical measures of each of said tuples further comprises the step of using cells to determine a baseline of said monitored system.

4. The method of claim 3, wherein said monitored system comprises an enterprise software application (ESA).

5. The method of claim 1, wherein each of said dimensions defines a monitored entity in said monitored system.

6. The method of claim 1, wherein each of said plurality of dimensions comprises at least one of: a service, a function, a service link, a transaction, and an external system.

7. The method of claim 6, wherein said dimensions are incrementally added by a user.

8. The method of claim 6, wherein each of said plurality of tuple schemas comprises any of a service by function, a transaction by service, all services, and all functions.

9. The method of claim 8, wherein said tuple schemas are configured by a user.

10. The method of claim 1, wherein said measured value comprises any of a throughput, a response time, and a monetary value.

11. The method of claim 1, wherein each of said events comprises any of a canonical message, and an input data class.

12. The method of claim 11, wherein said canonical message comprises pairs of dimensions and dimension values.

13. The method of claim 1, wherein each of said raw objects comprises any of a service call, a raw message, and a system parameter.

14. A computer software product readable by a machine, tangibly embodying a program of instructions executable by the machine to implement a method for context modeling to detect content related problems in a monitored system and to diagnose a root cause of said problems, said method comprising the steps of:
defining a data model comprising a plurality of dimensions and a plurality of tuple schemas; wherein each of said plurality of dimensions defines content to be collected and each of said plurality of tuple schemas defines a context in which said content is analyzed;
collecting a plurality of raw objects on said monitored system;
dynamically deriving dimension values on said plurality of dimensions from said raw objects to generate events;
dynamically classifying each of said events to tuples based on the dimension values of said events; and
for each of said tuples computing statistical measures based on at least one measure value defined in said tuple schema.

15. A context analyzer for performing context modeling of a monitored system, said context analyzer comprising:
a classifier for dynamically classifying a plurality of events to a plurality of tuples; and
a statistics calculator for calculating statistics according to at least one predefined measured value.

16. The context analyzer of claim 15, said classifier further comprising:
means for classifying said plurality of events to a plurality of tuples based on dimension values of said events.

17. The context analyzer of claim 16, wherein each said dimension values is associated with a dimension.

18. The context analyzer of claim 17, wherein said dimension is defined in a tuple schema.

19. The context analyzer of claim 18, said tuple schema comprising a definition of said measured value.

20. The context analyzer of claim 18, wherein said dimension comprises any of a service, a function, a service link, a transaction, and an external system.

21. The context analyzer of claim 18, wherein each of said tuple schema defines a relation between said dimension, wherein said relation is any of a service by function, a transaction by service, all services, and all functions.

22. The context analyzer of claim 18, wherein said measured value comprises any of a throughput, a response time, and a monetary value.

23. A method for performing content and context modeling, comprising the steps of:
collecting raw objects;
extracting dimension values from raw messages;
generating canonical messages;
updating relevant tuples based on said dimension values;
updating statistical measures;
saving statistical measures of a tuple in at least one cell; and
saving said cell in a database.

24. An automated monitoring system, comprising:
a plurality of data collectors, for capturing service call data;
a correlator for classifying raw objects received from said data collectors;
a context analyzer for analyzing events and classifying said events into corresponding tuples and calculating statistics accordingly; and
a database for receiving and storing said statistics.
